(19) United States
(12) Patent Application Publication
(10) Pub. No.: US 2019/0280514 A1
(43) Pub. Date: Sep. 12, 2019

(54) MOBILE DEVICE POWER MANAGEMENT SYSTEM

(71) Applicant: Ford Global Technologies, LLC, Dearborn, MI (US)

(72) Inventor: Jose Emmanuel Ramirez Lluvias, Distrito Federal (MX)

(21) Appl. No.: 15/916,675

(22) Filed: Mar. 9, 2018

(51) Int. Cl. H02J 7/04; H02J 7/00; H01R 13/66

(52) U.S. Cl. CPC H02J 7/045; H02J 7/0047; H02J 2007/0098; H02J 2007/005; H01R 13/6675

(57) ABSTRACT

A system for a vehicle includes a controller configured to, responsive to detecting mobile device connector terminals being joined to corresponding terminals of an electrical port of the vehicle, close a relay electrically in series with the port to charge the device via the port, open the relay to inhibit charging responsive to a device battery charge level received via a Bluetooth Low Energy (BLE) connection with the device being greater than a first threshold, and close the relay to reactivate charging responsive to a subsequent charge level received via the BLE connection being less than a second threshold, wherein the second threshold is less than the first threshold.

### TECHNICAL HELD

The present disclosure relates to systems and methods for a mobile device power management system.

### BACKGROUND

A vehicle driver may connect their mobile devices to one or more electrical ports within interior of the vehicle in order to charge them. In one example, a battery of the device may be a rechargeable electrochemical battery, such as, but not limited to, a lead-acid battery, a nickel-based battery, a lithium-based battery, or a combination thereof. The battery may continuously receive electric charge while being connected to the port.

### SUMMARY

A system for a vehicle includes a controller configured to, responsive to detecting mobile device connector terminals being joined to corresponding terminals of an electrical port of the vehicle, close a relay electrically in series with the port to charge the device via the port, open the relay to inhibit charging responsive to a device battery charge level received via a Bluetooth Low Energy (BLE) connection with the device being greater than a first threshold, and close the relay to reactivate charging responsive to a subsequent charge level received via the BLE connection being less than a second threshold, wherein the second threshold is less than the first threshold.

A method includes, responsive to a mobile device being connected to an electrical port, closing, by a controller, a relay electrically in series with the port to charge the device via the port, opening the relay to inhibit charging, responsive to a charge level received from the device being greater than a first threshold, and closing the relay to reactivate charging responsive to the level being less than a second threshold less than the first.

A system for a vehicle includes a controller configured to detect that a mobile device is connected to an electrical port of the vehicle, close a relay electrically in series with the port to charge a battery of the connected device via the port, open the relay to inhibit charging the device, responsive to a first charge level received from the device being greater than a first threshold, and close the relay to activate charging, responsive to a second charge level received after the first charge level being less than a second threshold, wherein the second threshold is less than the first threshold.

### BRIEF DESCRIPTION OF THE DRAWINGS

FIG. 1 is a block diagram illustrating a vehicle including a personalized traffic congestion notification system;

FIG. 2 is a block diagram illustrating an example vehicle interior arrangement;

FIGS. 3A and 3B are block diagrams illustrating components of an example power management system;

FIG. 4 is a block diagram illustrating an example USB power management system of the vehicle; and

FIG. 5 is a flowchart illustrating an algorithm for controlling a flow of power to an accessory vehicle port.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A power management system for a vehicle electrical port may be configured to selectively provide and inhibit power flow through the port based on a current charge level of the connected device. In one example, the device may be in communication with the vehicle and may be configured to send a signal to the vehicle indicative of a device battery charge level.

The vehicle power management system may be configured to provide (or continue providing) power flow to the port responsive to detecting that the charge level of the connected device battery is less than a first threshold. In one example, the power management system may be configured to provide (or continue providing) energy flow to the port responsive to the battery charge level being less than 100%. In another example, the power management system may be configured to inhibit (or continue inhibiting) energy flow to the port responsive to detecting that the battery charge level of the connected device is approximately equal to 100%.

In still another example, the power management system may continue to inhibit energy flow to the port responsive to detecting that the battery charge level is both greater than a first threshold and a second threshold, wherein the second threshold is less than the first threshold. The second threshold may, for example, be a charge level that is less than 100%. In some instances, the power management system may continue to inhibit energy flow to the port responsive to the charge level of the connected device being greater than 85% immediately after having reached a level approximately equal to 100%.

An electrical port may include a plurality of connecting terminals, pins, and leads configured to establish an electrical connection between the vehicle and the connected device. In one example, the electrical port may include a power terminal V_{CC} and a ground terminal GND. In some instances, the power terminal V_{CC} wire may include a relay configured to interrupt energy flow when open. A vehicle controller may be configured to monitor and control energy flow to the port by selectively opening and closing the relay. The vehicle controller may be further configured to establish wireless communication with the device connected to the port and may be configured to request, from the device, data indicative of a device battery charge level.

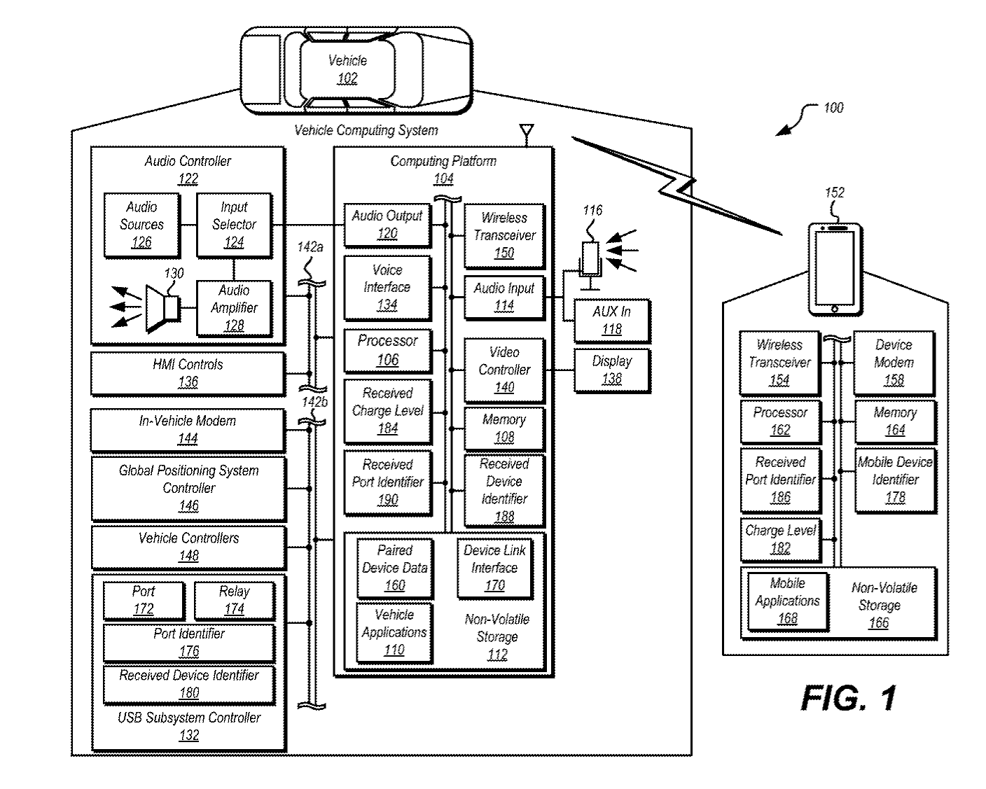

FIG. 1 illustrates an example diagram of a system 100 that may be used to provide telematics services to a vehicle 102. The vehicle 102 may be of various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

A computing platform 104 may include one or more processors 106 connected with both a memory 108 and a computer-readable storage medium 112 and configured to perform instructions, commands, and other routines in support of the processes described herein. For instance, the computing platform 104 may be configured to execute instructions of vehicle applications 110 to provide features such as navigation, roadway congestion alerts, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e.g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may also be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a Bluetooth® audio connection. In some examples, the audio input 114 may be configured to provide audio processing capabilities, such as pre-amplification of low-level signals, and conversion of analog inputs into digital data for processing by the processor 106.

The computing platform 104 may provide one or more audio outputs 120 to an input of the audio playback functionality of the audio controller 122. In other examples, the computing platform 104 may provide audio output to the occupants through use of one or more dedicated speakers (not illustrated). The audio controller 122 may include an input selector 124 configured to provide audio content from a selected audio source 126 to an audio amplifier 128 for playback through vehicle speakers 130, as well as, include audio content generated by the computing platform 104, audio content decoded from flash memory drives connected to a corresponding wired port or jack, audio content passed through the computing platform 104 from the auxiliary audio input 118, and so on. The computing platform 104 may utilize a voice interface 134 to provide a hands-free interface to the computing platform 104, as well as, support speech recognition, e.g., from audio received via the microphone 116 according to a grammar of available commands, and voice prompt generation for output via the audio controller 122.

The computing platform 104 may also receive input from human-machine interface (HMI) controls 136 configured to provide for occupant interaction with the vehicle 102, e.g., via one or more buttons or other HMI controls configured to invoke computing platform 104 functions. The computing platform 104 may also drive or otherwise communicate with one or more displays 138 configured to provide visual output to vehicle occupants by way of a video controller 140. The computing platform 104 may display the personalized notification, in addition to, or in place of, a corresponding audio notification, e.g., audio notification generated using audio output 120.

The computing platform 104 of the vehicle 102 may be configured to communicate with one or more mobile devices 152 positioned inside, outside, or within a predefined distance of the vehicle 102. Examples of the mobile devices 152 may include, but are not limited to, cellular phones, tablet computers, smart watches, laptop computers, portable music players, or other portable computing devices capable of communication with the computing platform 104. Similar to the computing platform 104, the mobile device 152 may include one or more processors 162 configured to execute instructions of mobile applications 168 loaded to a memory 164 of the mobile device 152 from storage medium 166.

In some examples, the computing platform 104 may include a wireless transceiver 150 one or more of a BLUETOOTH controller, a ZigBee® transceiver, a Wi-Fi transceiver, etc.) configured to communicate with a compatible wireless transceiver 154 of the mobile device 152. In some cases, the mobile devices 152 seeking permission to connect to the computing platform 104 may be identified by the computing platform 104 according to paired device data 160 maintained in the storage medium 112. In other examples, the wireless transceiver 150 of the vehicle 102 and the mobile device 152 may communicate using a BLUETOOTH Low Energy (BLE) network, e.g., the BLUETOOTH controller (an advertiser) of the vehicle 102 may broadcast a notification based, for instance, on a current geographic location of the vehicle 102 and a compatible transceiver (a scanner) of the mobile devices 152 may actively monitor for and process the broadcast upon receipt. An example of an advantage of the advertiser/scanner relationship may be that neither device has to be electronically paired and connected to authorize communication between the devices.

Additionally or alternatively, the computing platform 104 may communicate with the mobile devices 152 via a wide-area network (not illustrated) providing communications services, such as packet-switched network services (e.g., Internet access, VoIP communication services), to devices connected to the wide-area network. An example of a wide-area network may include a cellular telephone network. The computing platform 104 may, for instance, utilize the in-vehicle modem 144 of the vehicle 102 to connect to the wide-area network. Similar to the computing platform 104, the mobile devices 152 may connect to the wide-area network using a device modem 158 of the mobile device 152, such as via associated unique device identifiers (e.g., media access control (MAC) addresses, mobile device numbers (MDNs), Internet protocol (IP) addresses, mobile station international subscriber directory numbers (MSISDNs), international mobile subscriber identity (IMSI), etc.) identifying the communications of the mobile devices 152 over the wide-area network. In some examples, the mobile applications 168 may be configured to communicate with the computing platform 104 or other locally-networked devices and with the wide-area network.

The computing platform 104 may include a device link interface 170 to facilitate the integration of functionality of the mobile applications 168 into the grammar of commands available via the voice interface 134. The device link interface 170 may also provide the mobile applications 168 with access to vehicle features, such as information available to the computing platform 104 via the in-vehicle networks 142 or access to the display 138. An example of a device link interface 170 may be the SYNC APPLINK component of the SYNC system provided by The Ford Motor Company of Dearborn, Mich.

The computing platform 104 may be further configured to communicate with other components of the vehicle 102 via one or more in-vehicle networks 142. As shown, the computing platform 104 may communicate with a first set of vehicle systems, subsystems, or components over a first in-vehicle network 142a, and with a second set of vehicle 102 systems, subsystems, or components over a second in-vehicle network 142b. In other examples, the computing platform 104 may be connected to more or fewer in-vehicle networks 142. Additionally or alternately, one or more vehicle 102 systems, subsystem, or components may be connected to the computing platform 104 via different in-vehicle networks 142 than shown, or directly, e.g., without connection to an in-vehicle network 142.

The in-vehicle networks 142 may include one or more of a vehicle controller area network (CAN), an Ethernet network, or a media oriented system transfer (MOST), as some examples. The in-vehicle networks 142 may allow the computing platform 104 to communicate with other vehicle 102 systems, such as a universal serial bus (USB) subsystem controller 132, an in-vehicle modem 144, a global positioning system (GPS) controller 146 configured to provide current vehicle 102 location and heading information, and various vehicle controllers 148 configured to provide other types of information regarding the systems of the vehicle 102.

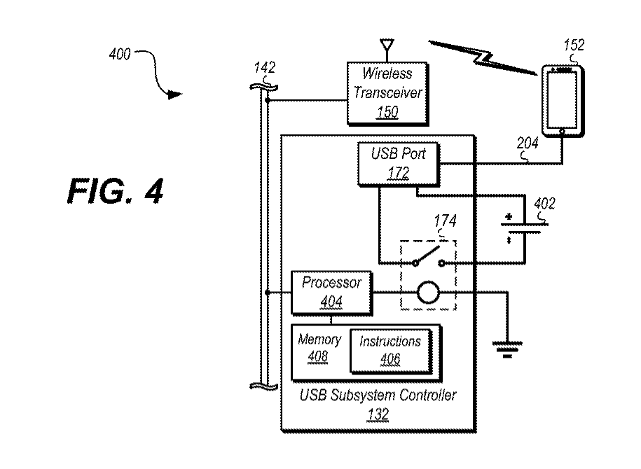

The USB subsystem controller 132 may be configured to monitor and control operation of an electrical port 172. Similar to the computing platform 104, as illustrated, for example, in FIG. 4, the USB subsystem controller 132 may include one or more processors 404 configured to execute instructions 406 loaded to memory 408 of the USB subsystem controller 132 from storage medium (not illustrated). As one example, the USB subsystem controller 132 may control operation of a relay 174 to selectively provide and inhibit power flow through the port 172. As some non-limiting examples, the relay 174 may be configured to complete electric circuit and provide power flow through the port 172 when closed and open the electric circuit and inhibit power flow through the port 172 when open.

The port 172 may be configured to receive a corresponding device 152 connector to establish electrical connection between the device 152 and the vehicle 102. In some examples, the USB subsystem controller 132, responsive to detecting that a connector has been joined to the port 172, may notify the computing platform 104 and selectively provide (activate) and inhibit power flow through the port 172 in response to one or more signals from the computing platform 104.

A port identifier 176 may be a unique numeric or alpha-numeric value associated with the port 172 and stored in the storage medium of the USB subsystem controller 132. In response to detecting that the mobile device 152 connector has been joined to the port 172, the USB subsystem controller 132 may send the port identifier 176 associated with the port 172 to the computing platform 104. The USB subsystem controller 132 may send the unique port identifier 176 associated with the port 172 to the mobile device 152 connected to the port 172. Additionally or alternatively, responsive to detecting that the mobile device 152 has been connected to the port 172, the USB subsystem controller 132 may request, from the connected mobile device 152, a device identifier 178, or a unique numeric or alpha-numeric attribute, associated with the mobile device 152. The USB subsystem controller 132 may associate the received device 152 identifier 180 with the port identifier 176 corresponding to the port 172 with which the mobile device 152 is connected.

Additionally or alternatively, the computing platform 104 may receive, from the mobile device 152 connected to (or paired with) the vehicle 102, a signal indicating current charge 182 of the mobile device 152 battery. Prior to, during, or after establishing communication with the computing platform 104, the mobile device 152 may send to the computing platform 104 one or both of a received port identifier 186 corresponding to the port 172 with which the mobile device 152 is connected and the mobile device identifier 178 associated with that mobile device 152. As one non-limiting example, responsive to a request, the mobile device 152 may send to the computing platform 104 of the vehicle 102 a signal including the battery charge level 182 and at least one of the received port identifier 186 and the mobile device identifier 178.

The charge level 182 may be a value that is a proportion or a share of a fully charged battery and may be expressed as one or more of a percentage, a natural number, an integer, an alpha-numeric attribute, and so on. In one example, the mobile device 152 may be in communication with the computing platform 104 and may send a signal to the computing platform 104 indicative of the battery charge level 182 of the mobile device 152. Based on a charge level 184 received from the connected mobile device 152, the computing platform 104 may command the USB subsystem controller 132 to provide and inhibit power flow through the port 172.

Responsive to receiving the charge level 184, the computing platform 104 may determine, from the received device identifier 188 of the mobile device 152, a port identifier 190 corresponding to the port 172 with which that mobile device 152 is connected. Additionally or alternatively, responsive to receiving, from the mobile device 152, the charge level 184 signal including the port identifier 190, the computing platform 104 determine the mobile device identifier 188 associated with the received port identifier 190. The computing platform 104 may send a signal to the USB subsystem controller 132 to one of activate, maintain, or inhibit power flow to the port 172 corresponding to the received port identifier 190 and/or associated with the received device identifier 188 of the mobile device 152.

The USB subsystem controller 132 may close the relay 174 to provide power flow to the port 172 responsive to the charge level 184 of the connected device 152 battery being less than a first threshold. In one example, the USB subsystem controller 132 may be configured to close the relay 174 responsive to the battery charge level 184 being less than 100%. In another example, the USB subsystem controller 132 may open the relay 174 to inhibit energy flow to the port 172 responsive to detecting that the battery charge level 184 of the connected mobile device 152 is approximately equal to 100%. In some instances, based on the received charge level 184, the USB subsystem controller 132 may close and open the relay 174 corresponding to the port 172 previously associated with the received device 152 identifier 180.

In still another example, the USB subsystem controller 132 may continue to inhibit energy flow to the port 172 responsive to detecting that the battery charge level 184 is greater than a second threshold, wherein the second threshold is less than the first threshold. The second threshold may, for example, be a charge level that is less than 100%. In some instances, the USB subsystem controller 132 may continue to inhibit energy flow to the port 172 responsive to the charge level of the connected mobile device 152 being greater than 85%. Thus, the USB subsystem controller 132 may close and open the relay 174 corresponding to the port 172 previously associated with the received device 152 identifier 180 based on a comparison between the received charge level 184 and the first and second thresholds.

As some non-limiting possibilities, the vehicle controllers 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors, and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

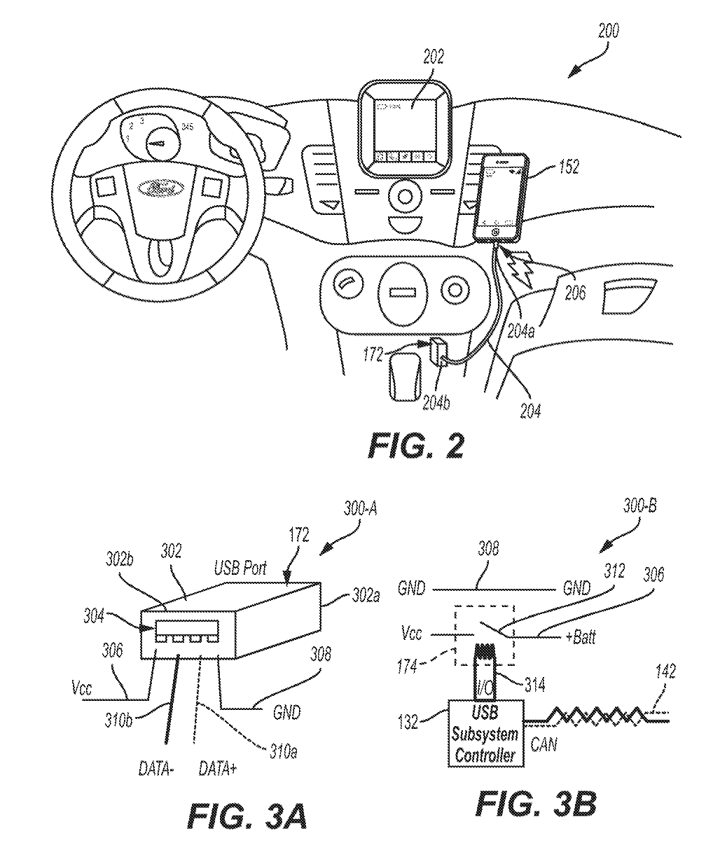

FIG. 2 illustrates an example an example interior arrangement 200 of the vehicle 102. The arrangement 200 may include a center stack 202 incorporating a plurality of buttons and controls, such as, but not limited to, controls for operating navigation system, stereo and video systems, and so on. The center stack 202 may further include a microphone for receiving and processing speech commands and speakers configured to provide audio output from one or more audio data sources. In some instances, the center stack 202 may include one or more electrical ports 172.

The electrical ports 172 may be electrical connection devices configured to selectively electrically join device terminals to complete an electrical circuit. Example configurations of the electrical ports 172 include, but are not limited to, single- or multi-pronged connectors, plugs, jacks, receptacles, sockets, and outlets. The electrical ports 172 may include one or more recesses and/or openings configured to selectively receive corresponding pins or prongs of an electrical connector. Additionally or alternatively, the electrical ports 172 may include one or more electrical wires configured to selectively coupled with corresponding recesses of a connector of an external device, e.g., the mobile device 152.

In one example, a connector 204 including first and second connector ends 204a, 204b may be configured to electrically connect the mobile device 152 and the vehicle 102. The first connector end 204a of the connector 204 may be configured to selectively connect to corresponding recesses of a mobile device port 206 and the second connector end 204b of the connector 204 may be configured to selectively connect to corresponding recesses of the port 172.

FIG. 3A illustrates an example arrangement 300-A of the port 172 configured to electrically connect one or more mobile devices 152 to the vehicle 102. A body 302 of the port 172 may include first and second body ends 302a, 302b, respectively. The first body end 302a may be configured to connect to, or otherwise interface with, one or more components of the USB subsystem controller 132 and/or the in-vehicle network 142. Recesses of the second body end 302b may be configured to receive corresponding terminals of the second connector end 204b of the mobile device connector 204.

The port body 302 may include a plurality of recesses or openings 304 housing one or more wire terminals, pins, and leads configured to establish an electrical connection between the vehicle 102 and the connected mobile device 152. In one example, the port body 302 may include a power terminal V_{CC} 306, a ground terminal GND 308, and a pair of data terminals 310. The electrical ports 172 may be configured to electrically join mobile device 152 terminals to the vehicle 102 to complete an electrical circuit.

FIG. 3B illustrates an example arrangement 300-B of the relay 174 configured to control power flow to the connected devices of the vehicle 102. In some instances, the power terminal V_{CC} 306 wire may include the relay 174 having an armature 312 and a coil 314. The relay 174 may be configured to interrupt energy flow when the coil 314 is deenergized and/or the armature 312 is open. Additionally or alternatively, the relay 174 may be configured to transfer battery energy when the coil 314 is being energized and/or the armature 312 is closed.

In one example, the USB subsystem controller 132 may be configured to monitor and control energy flow to the port 172, via the power terminal V_{CC} 306 terminal, by selectively energizing and deenergizing the coil 314 to cause the armature 312 of the relay 174 to close and open, respectively. In another example, the USB subsystem controller 132 may be configured to receive, e.g., via the in-vehicle network 142, a signal from the mobile device 152 indicative of the device 152 battery charge level. In yet another example, the USB subsystem controller 132 may be configured to, based on the received charge level of the device 152, selectively energize and deenergize the coil 314 to cause the armature 312 of the relay 174 to close and open.

FIG. 4 illustrates an example power management system 400 of the vehicle 102. The processor 404 of the USB subsystem controller 132 may monitor the in-vehicle network 142 and, responsive to detecting a predefined signal, may energize the coil 314 of the relay 174 to close the armature 312 to provide power flow through the port 172. In one example, the controller 132 may close the relay 174 responsive to detecting that the mobile device 152 is connected to the port 172 and/or responsive to a signal indicative of a mobile device battery charge level. Thus, the USB subsystem controller 132 may be configured to energize the coil 314 to cause the armature 312 to close responsive to a charge level signal.

The processor 404 of the controller 132 may compare the battery charge level received from the connected mobile device 152 to a first threshold. In some instances, the first threshold may be approximately equal to 100% charge level. The processor 404 may be configured to, for example, continue energizing the coil 314 of the relay 174 causing the armature 312 to remain closed and transferring energy to the port 172 responsive to detecting that the battery charge level of the connected mobile device 152 is less than the first threshold, e.g., less than 100% charge level. Additionally or alternatively, responsive to detecting that the received battery charge level is approximately equal to the first threshold, e.g., 100% charge level, the processor 404 may inhibit energy flow to the port 172, for example, by inhibiting energy flow to the coil 314 of the relay 174.

After causing the relay 174 to open, the processor 404 may monitor for one or more charge level signals from the mobile device 152. The processor 404 may compare the received charge level to a second threshold. The second threshold may be less than the first threshold. As one non-limiting example, if the first threshold charge level is a fully charged device 152, then the second threshold charge level may be a value less than 100%, such as, but not limited to, 85%, 70%, or 65% charge level, and so on. As another example, if the first threshold charge level is 50% then the second threshold charge level may be a value less than 50%, such as, but not limited to, 49% or 25% charge level, and so on. In some other instances, the processor 404 may continue to inhibit energy flow to the port 172 responsive to the charge level of the connected mobile device 152 being greater than the second threshold. Additionally or alternatively, the processor 404 may close the relay 174 to charge the mobile device 152 via the port 172 responsive to the received charge level of the connected mobile device 152 being less than the second threshold.

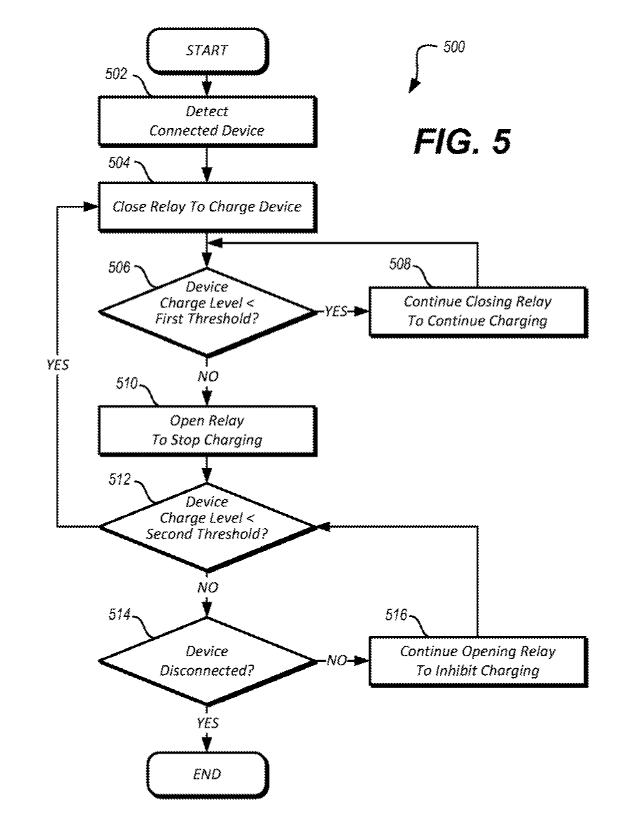

FIG. 5 illustrates an example process 500 for controlling a flow of power to an accessory vehicle port 172. The process 500 may begin at operation 502 where the controller 132 detects that the mobile device 152 is electrically connected to the port 172. In one example, the controller 132 may detect that one or more terminals of a given port 172 are electrically joined with corresponding contacts of the mobile device 152 connector. The controller 132 may request from the mobile device 152 the corresponding device identifier 178 and associate the received device identifier 180 with the port identifier 176 of the port 172 with which that mobile device 152 is connected.

Additionally or alternatively, the computing platform 104 may receive a signal from the mobile device 152 indicative of the device battery charge level 184. For example, the mobile device 152 may request to connect to the computing platform 104 in response to detecting via a transceiver that the BLUETOOTH controller of the computing platform 104 is advertising an available connection via a BLE network. Upon receiving a connection request from the mobile device 152 (a scanner), the computing platform 104 (the advertiser) may permit or deny the requested connection according to paired device data 160 maintained in the storage medium 112. In some examples, the computing platform 104 may request the battery charge level 182 responsive to establishing a BLE network connection with the mobile device 152 and/or responsive to a signal from the USB subsystem controller 132 that terminals of the port 172 are connected to (or otherwise physically interface with) corresponding terminals of the mobile device 152 connector.

At operation 504, the controller 132 closes the relay 174 to charge the mobile device 152. In some instances, the controller 132 closes the relay 174 of the port 172 corresponding to the port identifier 176 associated with the received device identifier 180 of the mobile device 152. In some other instances, closing the relay 174 includes energizing the coil 314 to cause the armature 312 to close such that electric energy may flow to the connected mobile device 152 via the port 172. While the relay 174 is described as including the coil 314 and the armature 312, other electrical and electromechanical configurations of the relay 174 are also contemplated. Thus, the relay 174 may include more or fewer elements cooperating in similar or different ways.

The controller 132, at operation. 506, determines whether the received device charge level 184 is less than a first threshold, e.g., 100% charge level. As one non-limiting example, the controller 132 may receive the device charge level signal via the in-vehicle network 142 responsive to the mobile device 152 being electrically connected, e.g., via physical joining of respective electrical terminals or contacts, to the port 172.

At operation 508, the controller 132 may maintain the relay 174 in a closed position to continue charging the mobile device 152 responsive to the received device charge level 184 being less than a first threshold. Stated another way, responsive to the received device charge level 184 being less than 100%, the controller 132 may continue energizing the coil 314 of the relay 174 causing the armature 312 to remain closed thereby continuing transferring energy to the port 172. In some instances, the controller 132 continues to energize the relay 174 of the port 172 corresponding to the port identifier 176 associated with the received device identifier 180 of the mobile device 152 that provided the received charge level 184.

The controller 132 may proceed to operation 510 responsive to the received charge level 184 being approximately equal to a first threshold, e.g., 100% charge level. In some instances, responsive to the received device charge level 184 being approximately equal to 100% charge level, the controller 132, at operation 510, inhibits energy flow to the port 172, for example, by inhibiting energy flow to the coil 314 of the relay 174 causing the armature 312 to open and the charging to seize. In some instances, the controller 132 inhibits energy flow to the relay 174 of the port 172 corresponding to the port identifier 176 associated with the received device identifier 180 of the mobile device 152 that provided the received charge level 184.

After opening the relay 174 to stop charging, the controller 132 monitors for one or more charge level signals from the mobile device 152. At operation 512, the controller 132 compares the received charge level 184 to a second threshold, wherein the second threshold may be less than the first threshold. Responsive to the received device charge level 184 being less than the second threshold, the process 500 may proceed to operation 504 where the controller 132 may close the relay 174 to charge the mobile device 152 via the port 172.

Responsive to the charge level 184 of the connected mobile device 152 being greater than the second threshold, the controller 132, at operation 516, continues to inhibit energy flow to the port 172. In some instances, the controller 132 continues to inhibit energy flow to the relay 174 of the port 172 corresponding to the port identifier 176 associated with the received device identifier 180 of the mobile device 152 that provided the received charge level 184.

Additionally or alternatively, before or after one or more operations 502-516 of the process 500, the controller 132 may determine whether the mobile device 152 has been disconnected from the port 172. For example, at operation 514, the controller 132 determines whether the mobile device 152 has been disconnected responsive to detecting, at operation 512, that the received device charge level 184 is greater than the second threshold. As some non-limiting examples, the controller 132 may determine that the mobile device 152 has been disconnected responsive to detecting that the charge level 184 signal has not been received from the mobile device 152, responsive to detecting that a periodic request to confirm the mobile device identifier 178 has not been responded to by the mobile device 152.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle comprising:
a controller configured to, responsive to detecting mobile device connector terminals being joined to corresponding terminals of an electrical port of the vehicle, close a relay electrically in series with the port to charge the device via the port, open the relay to inhibit charging responsive to a device battery charge level received via a Bluetooth Low Energy (BLE) connection with the device being greater than a first threshold, and close the relay to reactivate charging responsive to a subsequent charge level received via the BLE connection being less than a second threshold, wherein the second threshold is less than the first threshold.

2. The system of claim 1, wherein the port is a universal serial bus (USB) port.

3. The system of claim 2, wherein the relay is in series with a power terminal of the USB port.

4. The system of claim 1, wherein the controller is further configured to associate a device identifier received from the device with a port identifier corresponding to the port.

5. The system of claim 4, wherein the controller is further configured to close and open the relay of the port corresponding to the port identifier associated with the device identifier of the device that provided the charge level.

6. The system of claim 1, wherein the charge level is a present battery charge with respect to a full battery charge, and wherein the first threshold is 100% charge level and the second threshold is 85% charge level.

7. The system of claim 1, wherein the controller is further configured to open the relay responsive to detecting that the device has been disconnected from the port.

8. A method comprising:
responsive to a mobile device being connected to an electrical port, closing, by a controller, a relay electrically in series with the port to charge the device via the port;
opening the relay to inhibit charging, responsive to a charge level received from the device being greater than a first threshold; and
closing the relay to reactivate charging responsive to the level being less than a second threshold less than the first.

9. The method of claim 8, wherein the port is a universal serial bus (USB) port.

10. The method of claim 9, wherein the relay is in series with a power terminal of the USB port.

11. The method of claim 8 further comprising associating a device identifier received from the device with a port identifier corresponding to the port.

12. The method of claim 11 further comprising closing and opening the relay of the port corresponding to the port identifier associated with the device identifier of the device that provided the charge level.

13. The method of claim 8, wherein the charge level is a present battery charge with respect to a full battery charge, and wherein the first threshold is 100% charge level and the second threshold is 85% charge level.

14. The method of claim 8 further comprising opening the relay responsive to the device being disconnected from the port.

15. A system for a vehicle comprising:
a controller configured to
detect that a terminal of a mobile device connector is connected to a corresponding terminal of an electrical port of the vehicle,
close a relay electrically in series with the port to charge a battery of the connected device via the port,
establish a BLUETOOTH Low Energy (BLE) network connection with the device and request via the connection a first charge level,
open the relay to inhibit charging the device, responsive to the first charge level being greater than a first threshold, and
close the relay to activate charging, responsive to a second charge level received alter the first charge level being less than a second threshold, wherein the second threshold is less than the first threshold.

16. The system of claim 15, wherein the port is a universal serial bus (USB) port and the relay is in series with a power terminal of the USB port.

17. The system of claim 15, wherein the controller is further configured to associate a device identifier received from the device with a port identifier corresponding to the port.

18. The system of claim 17, wherein the controller is further configured to close and open the relay of the port corresponding to the port identifier associated with the device identifier of the device that provided the charge level.

19. The system of claim 15, wherein the charge level is a present battery charge with respect to a full battery charge, and wherein the first threshold is 100% charge level and the second threshold is 85% charge level.

20. The system of claim 15, wherein the controller is further configured to open the relay responsive to detecting that the device has been disconnected from the port.
